(19) United States
(12) Patent Application Publication
(10) Pub. No.: US 2019/0239296 A1
(43) Pub. Date: Aug. 1, 2019

(54) MICROWAVE HEATING APPARATUS

(71) Applicant: FUJITSU LIMITED, Kawasaki-shi (JP)

(72) Inventor: Yoichi Kawano, Setagaya (JP)

(73) Assignee: FUJITSU LIMITED, Kawasaki-shi (JP)

(21) Appl. No.: 16/226,727

(22) Filed: Dec. 20, 2018

(30) Foreign Application Priority Data
Jan. 31, 2018 (JP) 2018-015191

(51) Int. Cl. H05B 6/72; H05B 6/66; H05B 6/68; H01Q 9/04

(52) U.S. Cl. CPC H05B 6/72; H05B 6/664; H05B 2206/04; H01Q 9/0464; H05B 6/686

(57) ABSTRACT

A microwave heating apparatus includes a plurality of antennas that are two-dimensionally arranged in a heating chamber of the microwave heating apparatus, wherein a longitudinal orientation of an emission electrode included in one of the plurality of antennas is different from a longitudinal orientation of an emission electrode included in adjacent one of the plurality of antennas.

### CROSS-REFERENCE TO RELATED APPLICATION

This application is based upon and claims the benefit of priority of the prior Japanese Patent Application No. 2018-15191, filed on Jan. 31, 2018, the entire contents of which are incorporated herein by reference.

### FIELD

The embodiments discussed herein are related to a microwave heating apparatus.

### BACKGROUND

Microwave heating apparatuses are apparatuses for heating an object to be heated placed in a heating chamber by emitting microwaves to the object from a microwave source to cause the object to absorb the microwaves. In such a microwave heating apparatus, an object to be heated is irradiated with a microwave that is emitted in a heating chamber and is repeatedly reflected by, for example, the wall surfaces of the heating chamber.

For such a microwave heating apparatus, a magnetron that is a kind of vacuum tube is usually used as a microwave source. However, by using a semiconductor device instead of a magnetron, the size and weight of a microwave heating apparatus may be reduced and the output controllability of the microwave heating apparatus may be improved. Examples of the semiconductor device include a semiconductor device using gallium nitride which may conduct a large current with a high breakdown voltage also in a high-frequency range.

Microwave heating apparatuses are expected to uniformly heat objects to be heated in ordinary cases. However, there is a case where a user wants to heat only a part of an object to be heated in a microwave heating apparatus. For example, when boxed meal the contents of which are, for example, salad, cooked rice, and meat is warmed, a user wants to warm only the cooked rice and the meat and does not want to warm the salad. In a case where the user uniformly heats the boxed meal in a microwave heating apparatus, the salad the user does not want to warm is heated up.

A microwave heating apparatus that may partially heat an object to be heated by emitting microwaves to the object is therefore considered. However, since various food items are included in respective narrow regions in boxed meal, it is desirable that there be no clearance between regions to be subjected to partial heating and the regions be of high density to heat the food items to respective desired temperatures.

It is therefore desirable that a microwave heating apparatus perform partial heating upon an object to be heated, reduce the clearance between regions to be subjected to partial heating, and increase the densities of the regions.

The followings are reference documents.

### [Document 1] Japanese Laid-open Patent Publication No. 2017-16951,

### [Document 2] Japanese Laid-open Patent Publication No. 2010-92794 and

[Document 3] International Publication Pamphlet No. WO 2017/022711.

### SUMMARY

According to an aspect of the embodiments, a microwave heating apparatus includes a plurality of antennas that are two-dimensionally arranged in a heating chamber of the microwave heating apparatus, wherein a longitudinal orientation of an emission electrode included in one of the plurality of antennas is different from a longitudinal orientation of an emission electrode included in adjacent one of the plurality of antennas.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a first diagram describing a patch antenna;

FIG. 2 is a second diagram describing a patch antenna;

FIG. 3 is a diagram illustrating the configuration of an antenna according to a first embodiment;

FIG. 4 is a cross-sectional view of an antenna according to the first embodiment;

FIG. 5 is a first diagram describing the arrangement of antennas according to the first embodiment;

FIG. 6 is a second diagram describing the arrangement of antennas according to the first embodiment;

FIG. 7 is a third diagram describing the arrangement of antennas according to the first embodiment;

FIG. 8 is a diagram illustrating the configuration of a microwave heating apparatus according to the first embodiment;

FIG. 9 is a diagram describing a microwave heating apparatus according to the first embodiment;

FIG. 10 is a diagram illustrating the configuration of a semiconductor device used in a microwave heating apparatus;

FIG. 11 is a diagram illustrating the configuration of an antenna according to a second embodiment;

FIG. 12 is a cross-sectional view of an antenna according to the second embodiment;

FIG. 13 is a first diagram describing the arrangement of antennas according to the second embodiment;

FIG. 14 is a second diagram describing the arrangement of antennas according to the second embodiment;

FIG. 15 is a diagram describing a microwave heating apparatus according to the second embodiment;

FIG. 16 is a diagram illustrating the configuration of an antenna including a semicircular emission electrode;

FIG. 17 is a diagram illustrating the configuration of an antenna according to a third embodiment; and

FIG. 18 is a diagram describing the arrangement of antennas according to the third embodiment.

### DESCRIPTION OF EMBODIMENTS

Embodiments of the present disclosure will be described below. In the drawings, the same reference numeral is used to represent the same component or the same part so as to avoid repeated explanation.

### First Embodiment

A microwave heating apparatus according to the first embodiment will be described. A microwave heating apparatus according to this embodiment heats an object to be heated using microwaves emitted from antennas. In order to partially heat an object to be heated, a plurality of antennas are provided. In microwave heating apparatuses, microwaves that are electromagnetic waves of 2.45 GHz are usually used and, for example, planar antennas called patch antennas may be used.

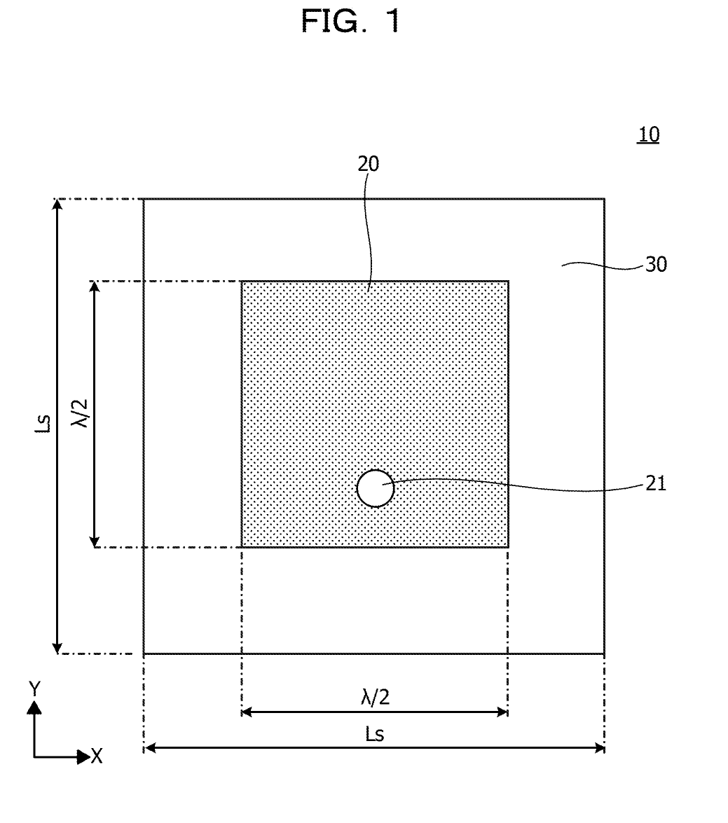

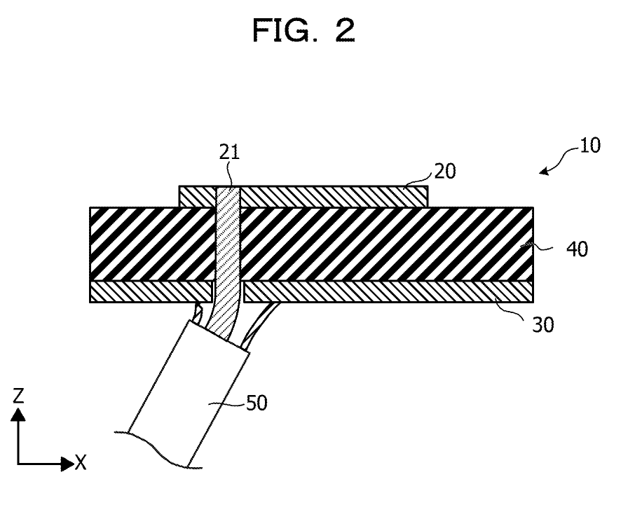

As illustrated in FIGS. 1 and 2, a patch antenna 10 includes an emission electrode 20 and a ground electrode 30. The emission electrode 20 includes a feeding unit 21. Between the emission electrode 20 and the ground electrode 30, a plate-like antenna substrate 40 is provided. Accordingly, in the patch antenna 10, the emission electrode 20 is formed on one surface of the plate-like antenna substrate 40 and the ground electrode 30 is formed on the other surface of the plate-like antenna substrate 40. In the patch antenna 10, between the emission electrode 20 and the ground electrode 30, space may be present.

As illustrated in FIG. 2, a coaxial cable 50 is connected to the patch antenna 10. An inner conductor of the coaxial cable 50 is connected to the feeding unit 21 in the emission electrode 20 and receives a signal. An outer conductor of the coaxial cable 50 is connected to the ground electrode 30 and has a ground potential. In a case where the patch antenna 10 emits electromagnetic waves of a wavelength λ, the shape of the emission electrode 20 is, for example, a square one side length of which is λ/2.

Specifically, in a case where microwaves of 2.45 GHz are emitted, the shape of the emission electrode 20 is a square approximately 61 mm on a side which is λ/2 of the wavelength λ of 122 mm of the microwaves. Ideally, it is desirable that the ground electrode 30 in the patch antenna 10 be infinite in size. However, from a practical standpoint, the size of the ground electrode 30 is set to have a width that is approximately twice the width of the emission electrode 20. In the case of microwaves of 2.45 GHz, the ground electrode 30 in the patch antenna 10 becomes a substantially square one side length Ls of which is approximately 122 mm.

In a case where the same antennas are two-dimensionally arranged, a part of a microwave emitted from one of the antennas enters adjacent one of them and is absorbed by the adjacent antenna. Thus, when a microwave emitted from an antenna, which is originally used for the heating of an object to be heated, is partially absorbed by an adjacent antenna, the heating efficiency of the object to be heated is reduced and an electronic circuit such as an amplifier connected to the antennas may be damaged. To avoid such entrance of a microwave into an adjacent antenna, the adjacent emission electrodes 20 are placed some distance away from each other.

The clearance between the emission electrodes 20 does not contribute to the heating of an object to be heated. In a case where this clearance is large, a partial heating resolution becomes low. This makes it difficult to efficiently heat only a desired food item. A case arises where partial heating of boxed meal is not realized, that is, a food item that a user does not want to warm is heated and a food item that the user wants to warm is not appropriately heated to a desired temperature.

(Antenna)

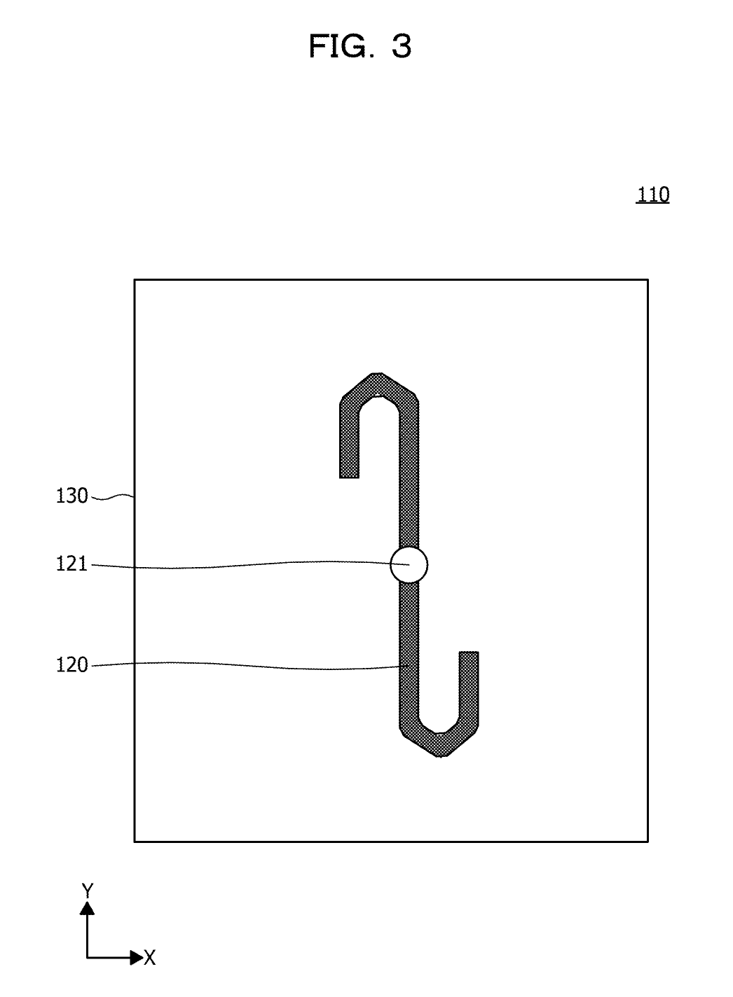

As illustrated in FIG. 3, an antenna 110 used in a microwave heating apparatus according to the first embodiment includes an emission electrode 120 and a ground electrode 130. The emission electrode 120 includes a feeding unit 121. The emission electrode 120 extends from the feeding unit 121 in opposite directions and has the length of λ/2. That is, the antenna 110 is an open stub antenna having the length of λ/2. In the antenna 110 illustrated in FIG. 3, microwaves polarized in a Y direction that is the longitudinal direction of the emission electrode 120 are emitted. Although the emission electrode 120 is bent in the antenna 110 illustrated in FIG. 3 for the miniaturization of the antenna 110, the longitudinal direction of the emission electrode 120 is the Y direction.

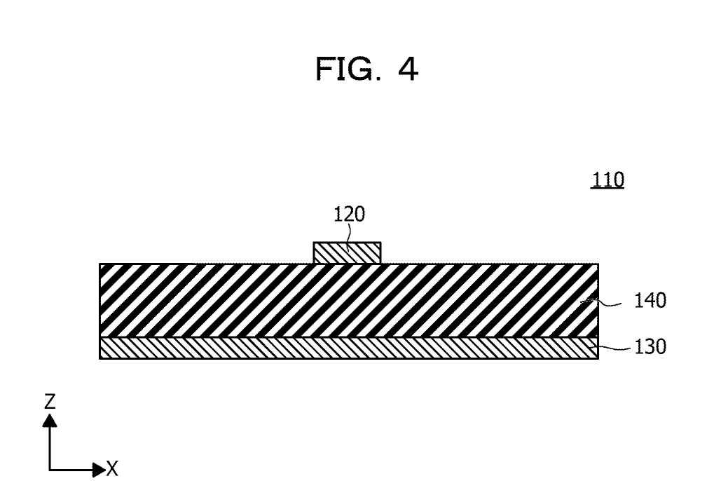

FIG. 4 is a cross-sectional view of the antenna 110. In the antenna 110, the emission electrode 120 is formed on one surface of a plate-like antenna substrate 140 and the ground electrode 130 is formed on the other surface of the plate-like antenna substrate 140. The emission electrode 120 and the ground electrode 130 are made of a metal such as copper. The plate-like antenna substrate 140 is made of a dielectric such as alumina (Al₂O₃) whose thickness is 100 μm to 200 μm. The plate-like antenna substrate 140 may be formed of a printed circuit board (PCB) whose thickness is 1 mm to 2 mm.

(Arrangement of Antennas)

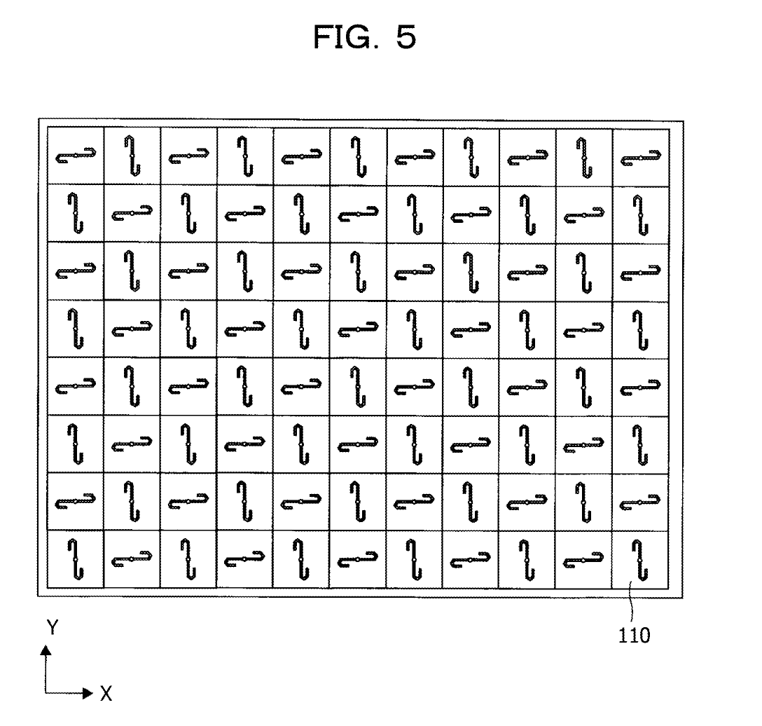

In a microwave heating apparatus according to this embodiment, on the bottom surface of a heating chamber, the antennas 110 are two-dimensionally arranged in an X direction and a Y direction as illustrated in FIG. 5. The X direction and the Y direction are orthogonal to each other.

In order to set all of the longitudinal directions of the emission electrodes 120 in the two-dimensionally arranged antennas 110 in the same direction, a method is considered of arranging the antennas 110 such that all of the longitudinal directions of the emission electrodes 120 in the antennas 110 become the Y direction. In this case, since the longitudinal directions of the emission electrodes 120 in the adjacent antennas 110 are the same direction (the Y direction), a microwave polarized in the Y direction emitted from one of the antennas 110 is partially absorbed by the other one of the antenna 110. Thus, in a case where a microwave emitted from the antenna 110, which is originally used for the heating of an object to be heated, is partially absorbed by the adjacent antenna 110, the heating efficiency of the object to be heated is reduced. In a case where a microwave emitted from the antenna 110 enters the adjacent antenna 110, an electronic circuit such as an amplifier connected to the antennas 110 may be damaged under the influence of the entered microwave.

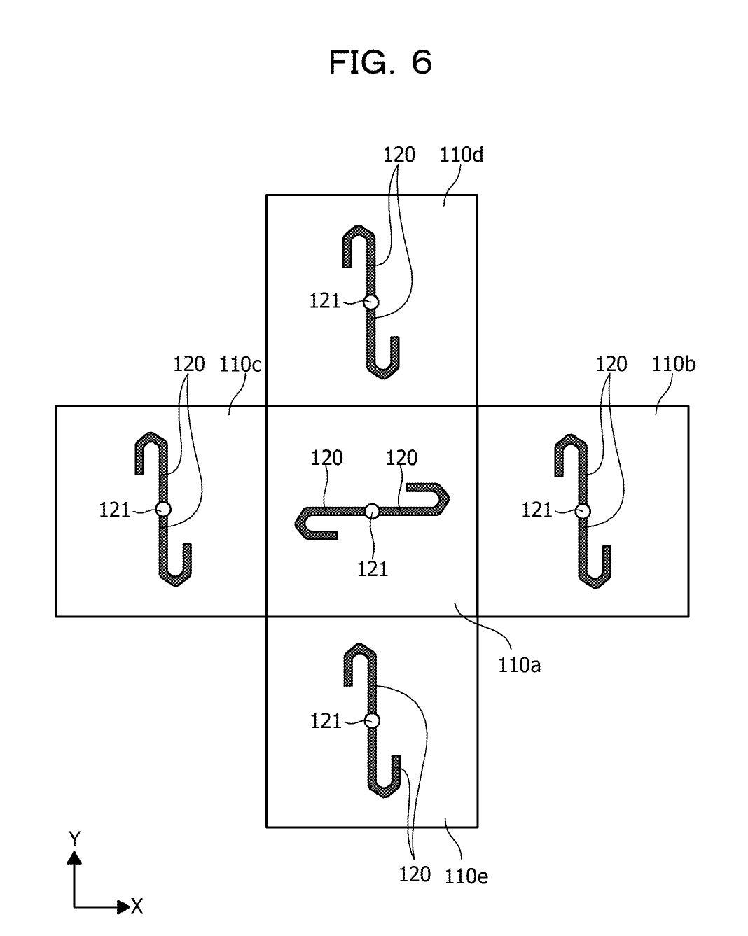

Accordingly, in this embodiment, the antennas 110 are arranged such that the longitudinal orientations of the emission electrodes 120 in the adjacent antennas 110 are different from each other by 90° as illustrated in FIG. 6. Specifically, antennas 110b, 110c, 110d, and 110e each including the emission electrode 120 whose longitudinal direction is the Y direction are arranged closest to an antenna 110a including the emission electrode 120 whose longitudinal direction is the X direction.

That is, in this embodiment, the antennas 110 including the emission electrode 120 whose longitudinal direction is the X direction and the antennas 110 including the emission electrode 120 whose longitudinal direction is the Y direction are alternately arranged in the X and Y directions. Accordingly, in the X and Y directions, the antennas 110 whose longitudinal orientations are different are alternately arranged.

The antenna 110 including the emission electrode 120 whose longitudinal direction is the X direction emits a microwave polarized in the X direction and does not receive microwaves polarized in the Y direction but microwaves polarized in the X direction. Similarly, the antenna 110 including the emission electrode 120 whose longitudinal direction is the Y direction emits a microwave polarized in the Y direction and does not receive microwaves polarized in the X direction but microwaves polarized in the Y direction.

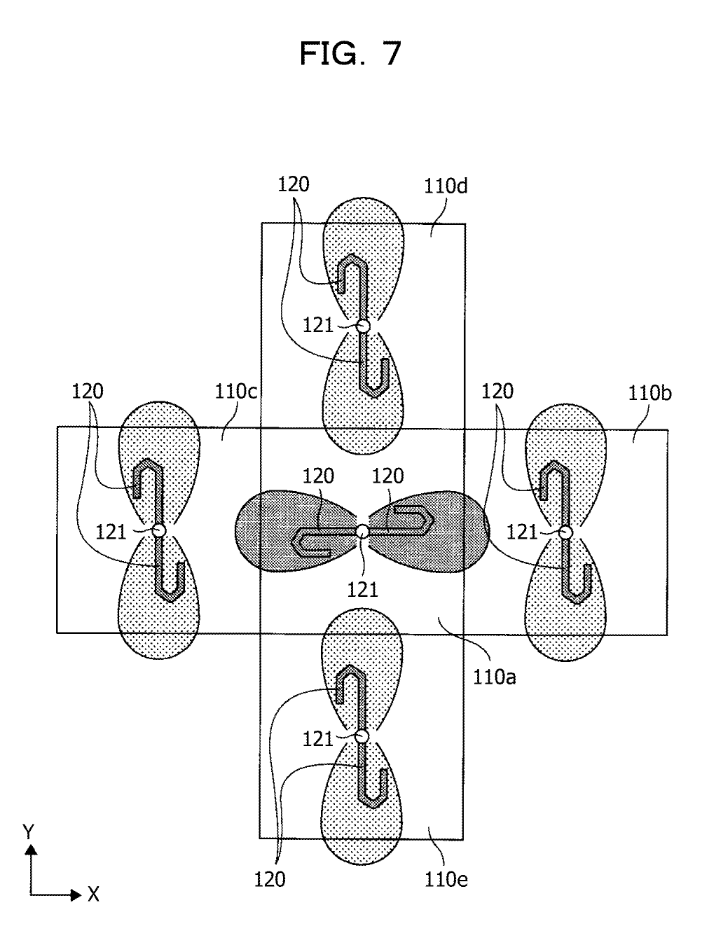

Accordingly, as illustrated in FIGS. 6 and 7, the antenna 110a including the emission electrode 120 whose longitudinal direction is the X direction emits a microwave polarized in the X direction. However, since the longitudinal directions of the emission electrodes 120 in the antennas 110b, 110c, 110d, and 110e closest to the antenna 110a are the Y direction, the microwave linearly polarization in the X direction emitted from the antenna 110a does not enter the antennas 110b, 110c, 110d, and 110e.

The antennas 110b, 110c, 110d, and 110e including the emission electrodes 120 whose longitudinal directions are the Y direction emit microwaves linearly polarization in the Y direction. However, since the longitudinal direction of the emission electrode 120 in the antenna 110a closest to the antennas 110b, 110c, 110d, and 110e is the X direction, the microwaves linearly polarization in the Y direction emitted from the antennas 110b, 110c, 110d, and 110e do not enter the antenna 110a. FIG. 7 is a schematic diagram illustrating the polarization of microwaves emitted from the emission electrodes 120 in the antennas 110a, 110b, 110c, 110d, and 110e.

Accordingly, in this embodiment, even if the adjacent antennas 110 are close to each other, the absorption of microwaves may be avoided, the reduction in the heating efficiency of an object to be heated may be suppressed, and the occurrence of a damage to, for example, an electronic circuit connected to the antennas 110 may be avoided.

(Microwave Heating Apparatus)

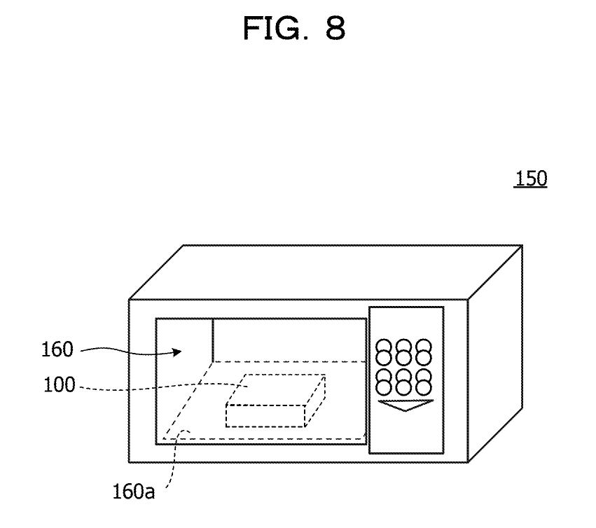

Next, a microwave heating apparatus according to this embodiment will be described. As illustrated in FIG. 8, a microwave heating apparatus 150 according to this embodiment includes a heating chamber 160 in which an object to be heated 100 is placed. The object to be heated 100 is placed on a bottom surface 160a of the heating chamber 160 in the microwave heating apparatus 150.

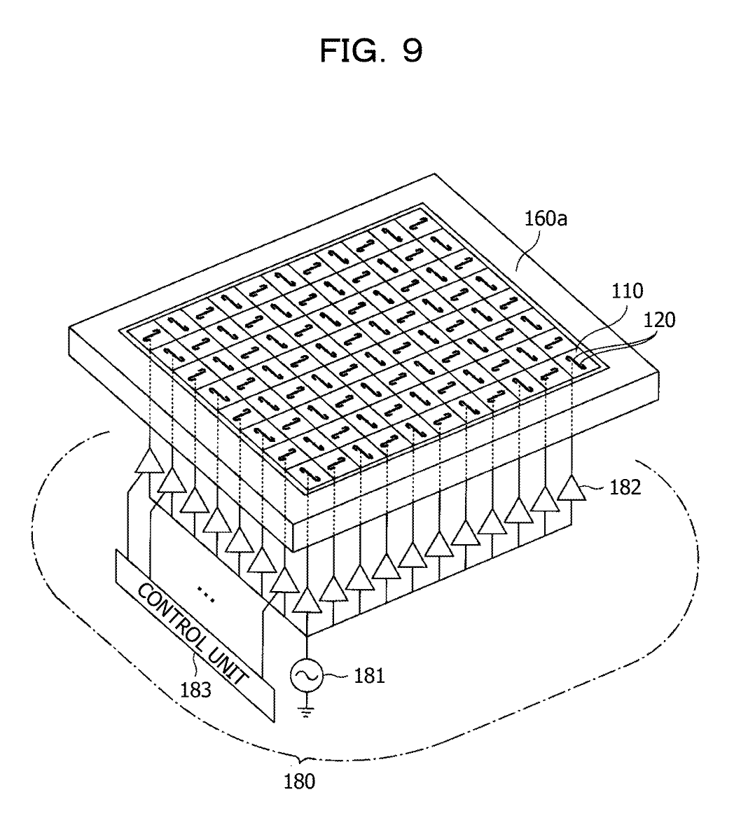

In this embodiment, on the bottom surface 160a of the heating chamber 160, the antennas 110 are two-dimensionally arranged as illustrated in FIG. 9. A power supply unit 180 is connected to each of the antennas 110. The power supply unit 180 includes a microwave source 181 for generating a microwave of 2.45 GHz, a plurality of amplifier units 182, and a control unit 183 for controlling each of the amplifier units 182.

In the power supply unit 180, the amplifier units 182 that are amplifiers are disposed for the respective antennas 110. The outputs of microwaves to be supplied to the emission electrodes 120 in the respective antennas 110 are controlled. That is, in the power supply unit 180, the single amplifier unit 182 is disposed for the single antenna 110. The corresponding amplifier unit 182 is connected to the emission electrode 120 in each of the antennas 110, and the number of the amplifier units 182 corresponds to the number of the antennas 110. The control unit 183 controls the output of a microwave to be supplied to the emission electrode 120 in each of the antennas 110.

In this embodiment, the antennas 110 are arranged such that the longitudinal orientations of the emission electrodes 120 in the adjacent antennas 110 are different from each other by 90°. As a result, the spacing between the adjacent antennas 110 may be reduced and the antennas 110 may be closely arranged. That is, the clearance between regions to be subjected to partial heating may be reduced and the densities of the regions to be subjected to partial heating may be increased.

Since the antennas 110 are closely disposed, a larger number of the antennas 110 may be disposed on condition that the area of the bottom surface 160a of the heating chamber 160 in a microwave heating apparatus is not changed. As a result, the object to be heated 100 may be efficiently heated.

(Semiconductor Device Used in Power Supply Unit)

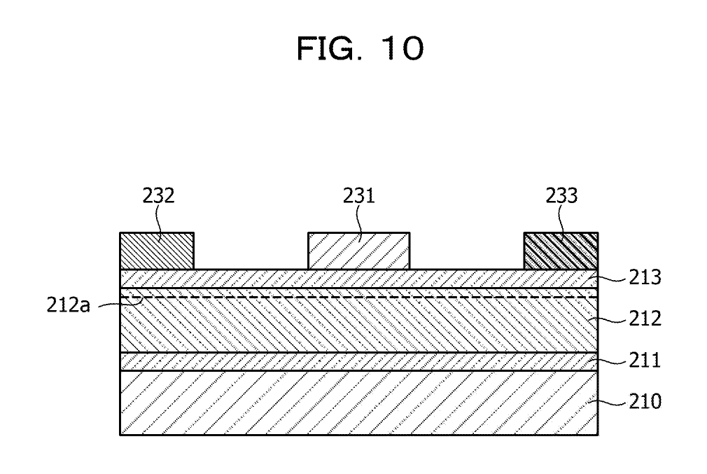

In this embodiment, in order to generate a microwave of a desired output level, a semiconductor device is used in a power supply unit. Specifically, for example, a high electron mobility transistor (HEMT) using a nitride semiconductor is used. An HEMT using a nitride semiconductor is obtained by laminating a nitride semiconductor layer on a substrate 210 made of, for example, SiC as illustrated in FIG. 10. That is, a buffer layer 211 made of, for example, AlN or GaN, an electron transit layer 212, and an electron supply layer 213 are laminated in this order on the substrate 210. The electron transit layer 212 is made of GaN. The electron supply layer 213 is made of AlGaN or InAlN. As a result, near the interface between the electron transit layer 212 and the electron supply layer 213, two dimensional electron gas (2DEG) 212a is generated. A gate electrode 231, a source electrode 232, and a drain electrode 233 are formed on the electron supply layer 213.

### Second Embodiment

(Antenna)

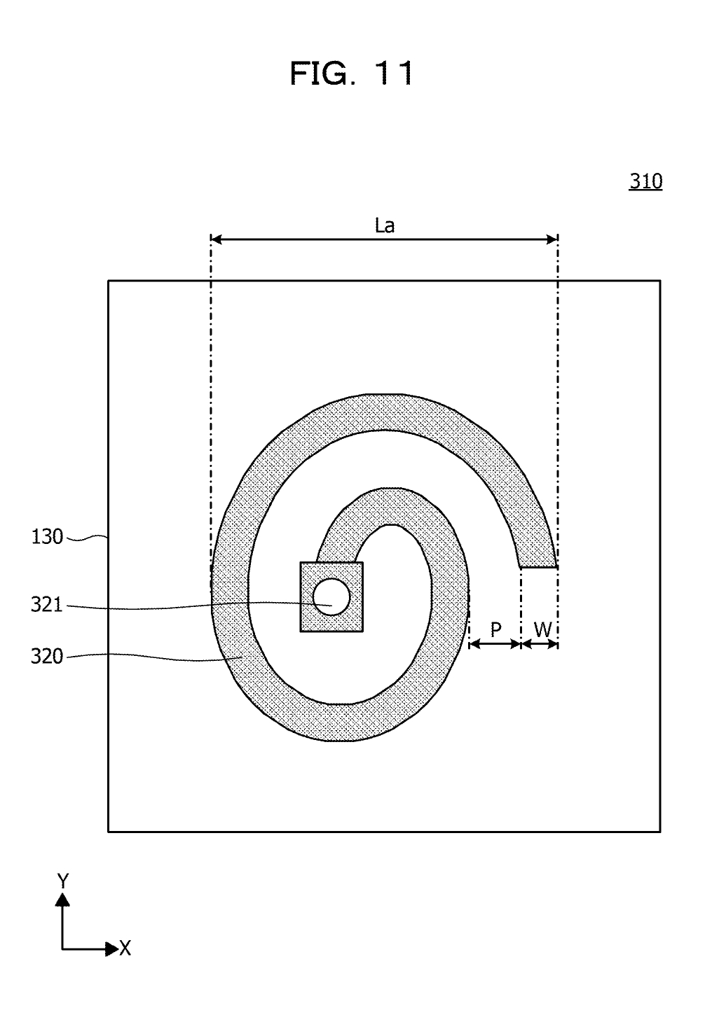

Next, a microwave heating apparatus according to the second embodiment and an antenna used in a microwave heating apparatus according to this embodiment will be described. An antenna used in a microwave heating apparatus according to this embodiment includes a spiral emission electrode. Specifically, as illustrated in FIG. 11, an antenna 310 includes an emission electrode 320 and the ground electrode 130. The emission electrode 320 has the length of λ/2 and is wound around a power supply unit 321 in a spiral fashion. The emission electrode 320 includes the power supply unit 321.

In this embodiment, for example, in the antenna 310, the emission electrode 320 whose width W is approximately 1 mm is wound 1.5 times in a spiral fashion and a space P between wound portions of the emission electrode 320 is approximately 6 mm. The antenna 310 includes the emission electrode 320 whose length is approximately 61 mm that is substantially λ/2 of the microwave of 2.45 GHz and may emit the microwave of 2.45 GHz. Since a length La of an outside shape of the emission electrode 320 in the antenna 310 is approximately 19 mm, the antenna 310 may be reduced in size as compared with the patch antenna 10 illustrated in FIG. 1. By using the antenna 310 in a microwave heating apparatus, the area of a region to be subjected to partial heating may be reduced. In this embodiment, by increasing the number of turns of the emission electrode 320 wound in a spiral fashion, the antenna 310 may be further reduced in size.

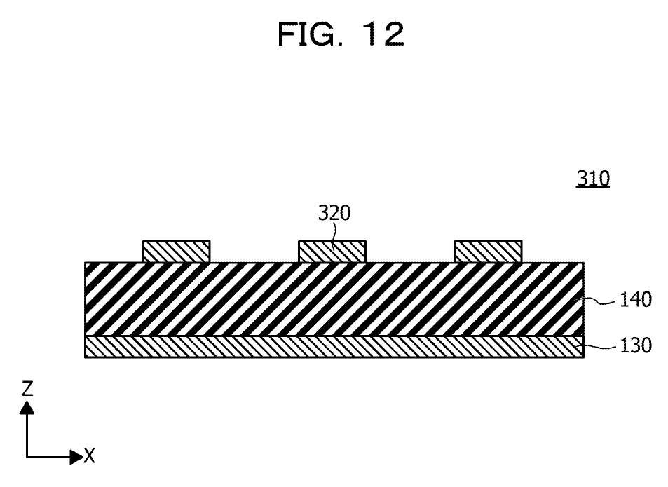

FIG. 12 is a cross-sectional view of the antenna 310. In the antenna 310, the emission electrode 320 is formed on one surface of the plate-like antenna substrate 140 and the ground electrode 130 is formed on the other surface of the ground electrode 130. The emission electrode 320 and the ground electrode 130 are made of metal such as copper.

(Arrangement of Antennas)

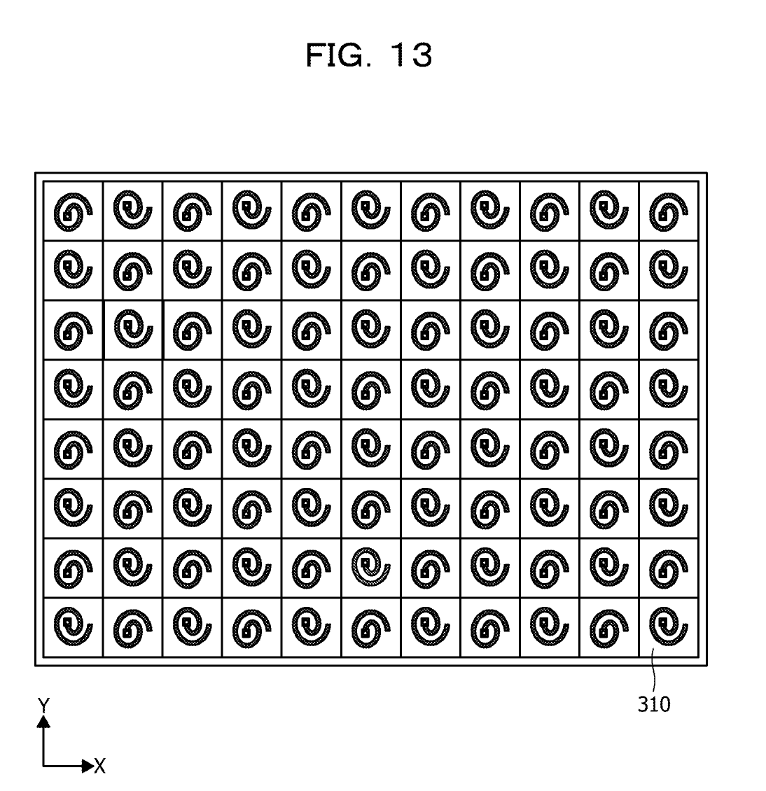

In a microwave heating apparatus according to this embodiment, on the bottom surface of the microwave heating apparatus, the antennas 310 are two-dimensionally arranged in the X direction and the Y direction as illustrated in FIG. 13.

In a case where the antennas 310 are two-dimensionally arranged, a method is considered of arranging the antennas 310 such that all of the winding directions of the emission electrodes 320 in the antennas 310 become the right-handed direction. In this case, since the winding directions of the emission electrodes 320 in the adjacent antennas 310 are the right-handed direction, a right-handed microwave emitted from one of the antennas 310 is partially absorbed by the other one of the antennas 310. Thus, in a case where a microwave emitted from the antenna 310, which is originally used for the heating of an object to be heated, is partially absorbed by the adjacent antenna 310, the heating efficiency of the object to be heated is reduced. In a case where a microwave emitted from the antenna 310 enters the adjacent antenna 310, an electronic circuit such as an amplifier connected to the antennas 310 may be damaged under the influence of the entered microwave.

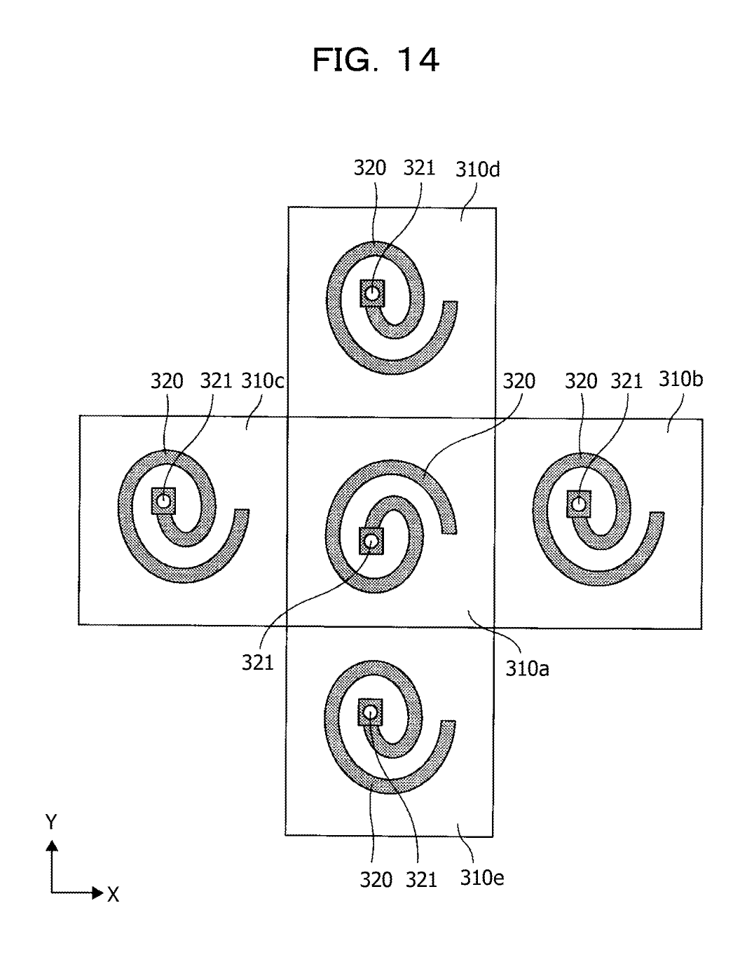

Accordingly, in this embodiment, the antennas 310 are arranged such that the winding directions of the emission electrodes 320 in the adjacent antennas 310 are opposite to each other as illustrated in FIGS. 13 and 14. Specifically, antennas 310b, 310c, 310d, and 310e including the emission electrodes 320 whose winding directions are the left-handed direction (counterclockwise direction) are arranged closest to an antenna 310a including the emission electrode 320 whose winding direction is the right-handed direction (clockwise direction).

That is, in this embodiment, the antennas 310 are two-dimensionally arranged in the X and Y directions such that the antenna 310 including the right-handed emission electrode 320 and the antenna 310 including the left-handed emission electrode 320 are alternately placed. Accordingly, in the X and Y directions, the antennas 310 whose winding directions are different are alternately arranged.

The antenna 310 including the right-handed emission electrode 320 emits a right-handed polarized microwave and does not receive a left-handed polarized microwave but a right-handed polarized microwave. Similarly, the antenna 310 including the left-handed emission electrode 320 emits a left-handed polarized microwave and does not receive a right-handed polarized microwave but a left-handed polarized microwave.

Accordingly, as illustrated in FIG. 14, a right-handed polarized microwave is emitted from the antenna 310a including the right-handed emission electrode 320. However, since the winding directions of the emission electrodes 320 in the antennas 310b, 310c, 310d, and 310e closest to the antenna 310a are the left-handed direction, the right-handed polarized microwave emitted from the antenna 310a does not enter the antennas 310b, 310c, 310d, and 310e.

Left-handed polarized microwaves are emitted from the antennas 310b, 310c, 310d, and 310e including the left-handed emission electrodes 320. However, since the winding direction of the emission electrode 320 in the antenna 310a closest to the antennas 310b, 310c, 310d, and 310e is the right-handed direction, the left-handed polarized microwaves emitted from the antennas 310b, 310c, 310d, 310e do not enter the antenna 310a.

Accordingly, in this embodiment, even if the adjacent antennas 310 are close to each another, the absorption of microwaves may be avoided, the reduction in the heating efficiency of an object to be heated may be suppressed, and the occurrence of damage to, for example, an electronic circuit connected to the antennas 310 may be avoided.

(Microwave Heating Apparatus)

Next, a microwave heating apparatus according to this embodiment will be described. The external view of a microwave heating apparatus according to this embodiment is the same as that illustrated in FIG. 8.

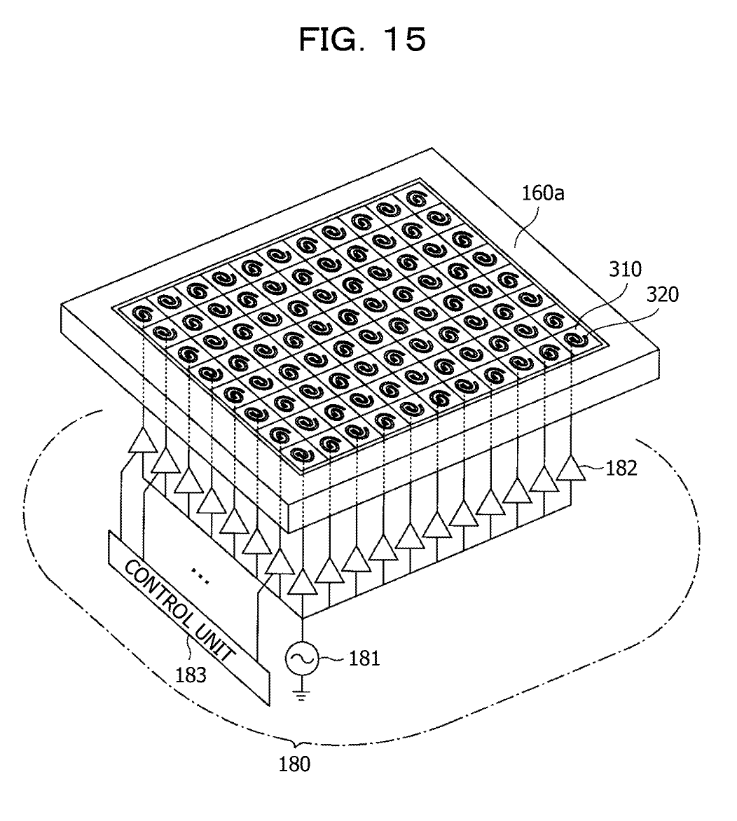

In this embodiment, on the bottom surface 160a of the heating chamber 160, the antennas 310 are two-dimensionally arranged as illustrated in FIG. 15. The power supply unit 180 is connected to each of the antennas 310. The power supply unit 180 includes, for example, the microwave source 181 for generating the microwave of 2.45 GHz, the amplifier units 182, and the control unit 183 for controlling each of the amplifier units 182.

In the power supply unit 180, the amplifier units 182 that are amplifiers are disposed for the respective antennas 310. The outputs of microwaves to be supplied to the emission electrodes 320 in the respective antennas 310 are controlled. That is, in the power supply unit 180, the single amplifier unit 182 is disposed for the single antenna 310. The corresponding amplifier unit 182 is connected to the emission electrode 320 in each of the antennas 310, and the number of the amplifier units 182 corresponds to the number of the antennas 310. The control unit 183 controls the output of a microwave to be supplied to the emission electrode 320 in each of the antennas 310.

In this embodiment, the antennas 310 are arranged such that the winding directions of the emission electrodes 320 in the adjacent antennas 310 are opposite to each other. As a result, the spacing between the adjacent antennas 310 may be reduced and the antennas 310 may be closely arranged. That is, the clearance between regions to be subjected to partial heating may be reduced and the densities of the regions to be subjected to partial heating may be increased.

Since the antennas 310 are closely disposed, a larger number of the antennas 310 may be disposed on condition that the area of the bottom surface 160a of the heating chamber 160 in a microwave heating apparatus is not changed. As a result, an object to be heated may be efficiently heated.

In a microwave heating apparatus according to this embodiment, the setting of heating target regions of an object to be heated may be finely set and the respective regions of the object to be heated may be efficiently heated to desired temperatures.

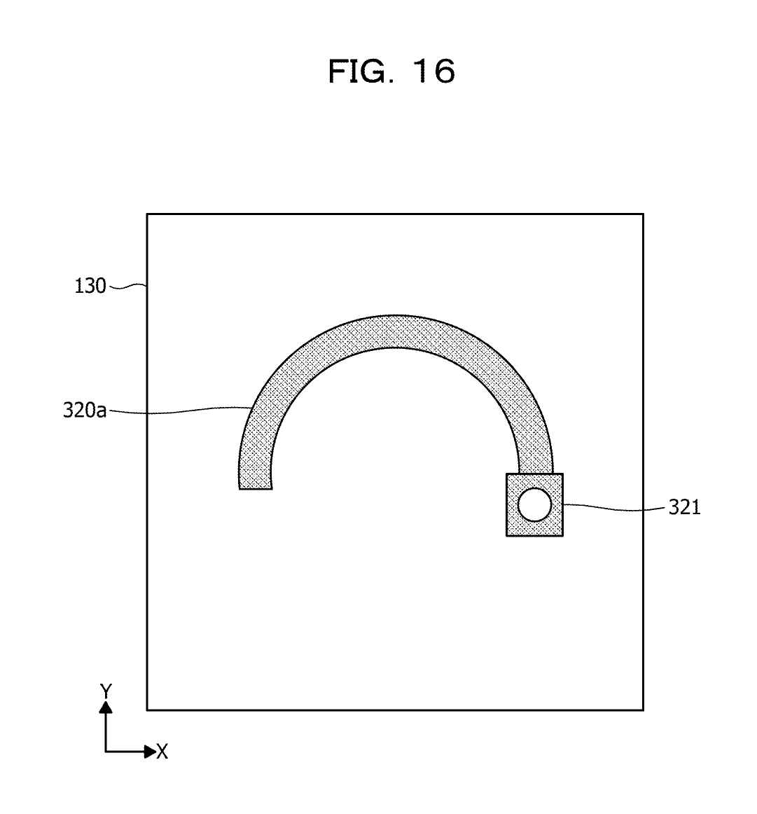

In this embodiment, the miniaturization of an antenna may be achieved even with a semicircular emission electrode 320a having the length of λ/2 as illustrated in FIG. 16. However, the miniaturization of an antenna may be achieved by increasing the number of turns of a spiral emission electrode.

The configuration other than the above-described configuration is the same as that according to the first embodiment.

### Third Embodiment

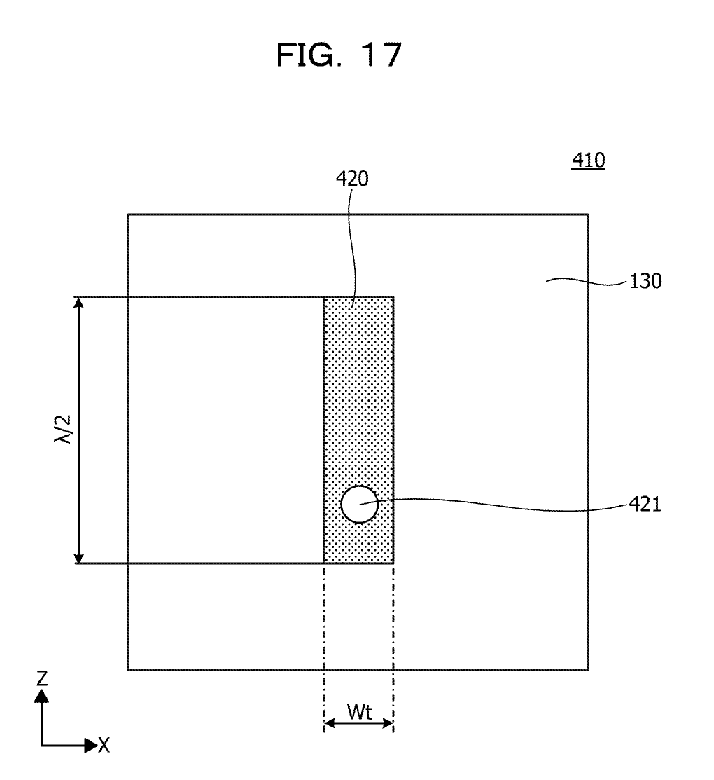

Next, the third embodiment will be described. In this embodiment, an emission electrode 420 in an antenna 410 is substantially rectangular in shape as illustrated in FIG. 17. Also in the antenna 410, a microwave linearly polarized in the longitudinal direction of the emission electrode 420 is emitted. In this embodiment, the shape of the emission electrode 420 is a rectangle with long sides whose width is approximately λ/2 and short sides whose width Wt is shorter than λ/2.

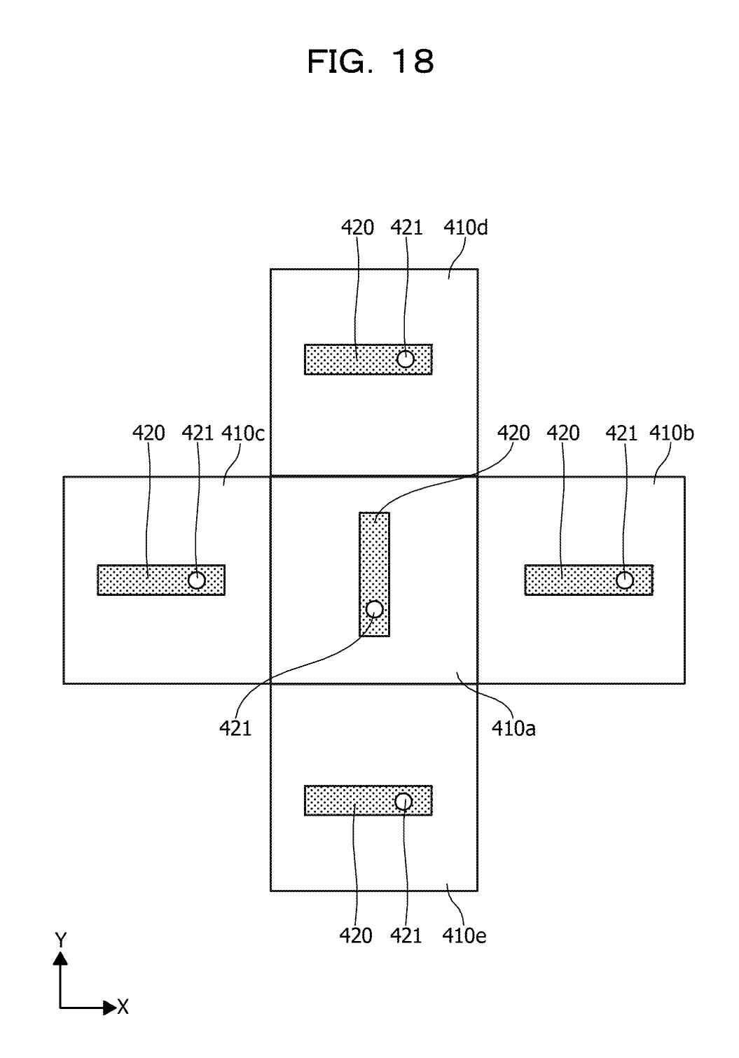

In this embodiment, the antennas 410 are arranged such that the longitudinal orientations of the emission electrodes 420 in the adjacent antennas 410 are different from each other by 90° as illustrated in FIG. 18. Specifically, antennas 410b, 410c, 410d, and 410e each including the emission electrode 420 whose longitudinal direction is the X direction are arranged closest to an antenna 410a including the emission electrode 420 whose longitudinal direction is the Y direction.

Thus, by forming the rectangular emission electrodes 420 and by arranging the antennas 410 such that the emission electrodes 420 in the adjacent antennas 410 have different orientations, the emission electrodes 420 in the antennas 410 may be placed close to each other. As a result, the clearance between antennas may be further reduced as compared with a case where the patch antennas 10 illustrated in FIG. 1 are used.

The antenna 410 according to this embodiment may be applied to a microwave heating apparatus according to the first embodiment. The configuration other than the above-described configuration is the same as that according to the first embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A microwave heating apparatus comprising:
a plurality of antennas that are two-dimensionally arranged in a heating chamber of the microwave heating apparatus,
wherein a longitudinal orientation of an emission electrode included in one of the plurality of antennas is different from a longitudinal orientation of an emission electrode included in adjacent one of the plurality of antennas.

2. The microwave heating apparatus according to claim 1,
wherein the antennas are arranged such that a longitudinal orientation of an emission electrode included in one of the antennas is different from a longitudinal orientation of an emission electrode included in adjacent one of the antennas by 90°.

3. The microwave heating apparatus according to claim 1,
wherein a power supply unit is connected to the antennas,
wherein amplifiers corresponding to the antennas are connected to the power supply unit, and
wherein microwaves of different output levels are emitted from the respective antennas.

4. The microwave heating apparatus according to claim 3,
wherein the respective amplifiers are controlled by a control unit included in the power supply unit.

5. The microwave heating apparatus according to claim 3,
wherein the power supply unit includes a semiconductor device formed of a nitride semiconductor.

6. A microwave heating apparatus comprising:
a plurality of antennas that are two-dimensionally arranged in a heating chamber of the microwave heating apparatus,
wherein emission electrodes included in the respective antennas are wound in a spiral fashion, and
wherein the antennas are arranged such that a winding direction of the emission electrode in one of the plurality of antennas is opposite to a winding direction of the emission electrode in adjacent one of the plurality of antennas.
